(19) United States
(12) Patent Application Publication
(10) Pub. No.: US 2011/0103189 A1
(43) Pub. Date: May 5, 2011

(54) ANOMALY DETECTOR FOR PIPELINES

(76) Inventor: Peter O. Paulson, Calgary (CA)

(21) Appl. No.: 13/000,473

(22) PCT Filed: Jun. 25, 2009
(86) PCT No.: PCT/CA09/00891

§ 371 Date: Dec. 21, 2010

Related U.S. Application Data
(60) Provisional application No. 61/075,497, filed on Jun. 25, 2008.

(51) Int. Cl. G01S 1/74; G01S 1/80; F17D 5/06

(52) U.S. Cl. 367/89; 367/93

(57) ABSTRACT

Apparatus for locating an object in a pipeline, comprising a transmitting station having means for transmitting in the pipeline acoustic emissions having a frequency in the range from 20 KHz to 200 KHz; a receiving station having a receiver capable of receiving the acoustic emissions transmitted by the transmitting station; one of the receiving station and the transmitting station being located at a known position on the pipeline and the other of the receiving station and the transmitting station being located on the object; and clock means to determine the time taken for the acoustic emissions to travel between the transmitting station and the receiving station.

This invention relates to apparatus and a method to locate an object in a pipeline. Particularly, it relates to apparatus and a method for locating a moveable object which has been introduced into the pipeline. In its preferred embodiments, it relates to locating the position of a detector unit for the detection of anomalies in pipelines that carry liquids, such as for example oil or water, or gases, such as for example natural gas.

### DISCUSSION OF THE PRIOR ART

It is frequently useful to know the position of an object which has been introduced into a pipeline, for example for maintenance or leak detection purposes. For example, it is sometimes necessary to know the position to a pipeline pig which has been introduced to clean a pipeline. Knowing the position enables the operator to predict when the pig will arrive at a pigging station, or to take steps to free it if it has become jammed.

A particular type of object, of which it would be useful to know the location within the pipeline at a particular time, is a detector unit which senses conditions in the pipeline.

Untethered detector units which move through a pipeline, sensing conditions as they go, have been known for many years. For example, the oil industry has long used untethered “pigs” which fill the cross-section of the pipeline and which are pushed through by the flowing oil. In both oil and water pipelines, untethered ball-like detector units have been used, such as the one shown in PCT Published application WO 2006/081671 of Pure Technologies Ltd. In the currently preferred form of the detector unit of that published application, the unit rolls along the bottom of a fluid-filled pipeline, pushed along by the fluid flow. There are also untethered powered detector units, which pass though the pipeline by means of their own motive power.

The detector unit is typically placed in the pipeline to detect anomalous conditions such as leaks, corrosion or pipe wall defects, using suitable known sensors to sense the particular anomalous condition. Obviously, it is necessary to determine as accurately as possible the location of the anomalous condition, so that it can be remedied or monitored further. To determine this location, it is usually important to know the location of the detector unit at the time the anomalous condition is noted. In most cases, methods using satellites (for example a GPS locating device) are not useable, because the pipeline is buried too far underground for such methods to work.

Various methods have been used to determine the location of detector units within pipelines. A crude determination can be made for detector units that are carried along by the fluid flow by knowing the average speed of flow of the liquid within the pipeline, and recording the elapsed time from when the unit was released to pass through the pipeline until it comes to the anomaly. This method is sometimes refined by having beacons which emit particular sound signatures at intervals along the pipeline (for example, at inspection ports) and using the times at which the detector unit passes the beacons to help calibrate the average flow rate for particular sections of the pipeline. If the detector is designed to roll along the bottom of the pipeline, the number of revolutions can be counted to provide an indication of distance travelled. If the detector unit is equipped with a magnetometer, this can sense elements of the pipe architecture such as welds in a metal pipeline or bell and spigot joints in a pipeline made of wire-wrapped concrete. Similarly, pressure and temperature sensors on the detector unit can often sense elements of pipe architecture such as places where other lines join or leave the pipeline being monitored, because liquid leaving or joining the pipeline being monitored affects the pressure or temperature in that pipeline.

Although these methods of determining the location of detector units are useful, they do not give a precise location for the detector unit. Fluid flow within a pipeline may not be constant, especially if the pipeline is partially filled with liquid or if it goes up or downhill. The measurement of the number of revolutions made by a rolling detector unit can sometimes be incorrect if the unit is entrained in the fluid in the pipeline and loses contact with the bottom of the pipeline. The sensing of pipe architecture may not be feasible if only incomplete or imprecise records exist of the locations of the architectural features.

It would therefore be useful to have an accurate and precise method of determining the location of an object which has been introduced into a pipeline, particularly a detector unit within the pipeline, and to have apparatus to perform that method.

### BRIEF DESCRIPTION OF THE INVENTION

It has now been discovered that an acoustic emission at high frequency is transmitted through pipelines with little loss in amplitude. This permits the emission to be received at a remote location, for example several kilometres away, without undue attenuation.

If the precise time of sending of the acoustic emission through the pipeline from a first location is determined, and the precise time of that the emission is received at a second remote location is determined, it is possible according to the invention to obtain a very precise measurement of the length of the pipeline between the location of sending and the location of receipt. To obtain the distance between the two locations, one determines the time taken by the acoustic emission to travel between the two locations, and multiplies this by the speed of sound of the particular frequency in the type of liquid within the pipeline. Where one of the first and second locations is a moveable object within the pipeline and the other is a known position along the pipeline, this provides a method for finding the location of the moveable object.

### DRAWINGS

The invention will be described with reference to the drawings, in which:

FIG. 1 is a representation (not to scale) of a detector unit equipped with a transmitting station according to the invention, and located within a pipeline, where the detector unit is an untethered ball rolling along the bottom of the pipeline. The pipeline is shown in section in order to show the detector unit.

FIG. 2 is a representation (not to scale) of a detector unit equipped with a transmitting station according to the invention, and located within a pipeline, where the detector unit is a pipeline pig. The pipeline is shown in section in order to show the detector unit.

FIG. 3 is a representation (not to scale) of a receiving station according to the invention, located at a known location on the pipeline, and other equipment associated with it. The pipeline and surrounding earth are shown in section in order to show the receiving station.

FIG. 4 is a representation (not to scale) of an alternate embodiment of the invention, showing a transmitting station on a pipeline and a detector unit equipped with a receiving station. The pipeline and surrounding earth are shown in section in order to show the receiving station and detector unit.

### DETAILED DESCRIPTION OF THE INVENTION

According to the invention, a transmitting station has a precise clock, and a means for emitting a high-frequency acoustic emission. At least one receiving station has an acoustic receiver positioned to receive sounds occurring within the pipeline, a precise clock and a recording device. The difference (if any) between the readings of the two clocks at the same absolute time is known, so that a correction can be made when calculating the time taken for an emission to travel between them. Preferably, the transmitting station is in a moveable detector unit and the receiving device is at a fixed location in or attached to the pipeline. The reason for this is that electric power is usually more readily available at a fixed location (where it can be supplied from a grid) than in a moveable device dependent on batteries or the like. Abundant electric power supply to the receiving station permits such station to be provided with amplifiers to boost the signal received.

In the preferred embodiment, the transmitting station is located aboard an untethered detector unit and the receiving station is located at a known fixed point in the pipeline, such as, for example, the point where the detector unit was launched in the pipeline or a point where the pipeline is accessible through an inspection port.

In a less preferred embodiment, the transmitting station is at a known fixed point in the pipeline and the receiving station is aboard the untethered detector unit.

In another embodiment useful when charting a pipeline of unknown configuration where the speed of sound in the fluid in the pipeline is known, the transmitting and receiving stations are located at fixed points along the pipeline, and the invention is used to determine the precise distance between the fixed points.

In another embodiment, useful when calibrating the system, both stations are fixed points along the pipeline at a known distance from one another, and the invention is used to determine the precise speed of sound of the frequency used in the type of fluid within the pipeline.

When the transmitting station is located aboard a moveable detector unit, it is particularly preferred to have several receiving stations in use at different locations along the pipeline. The transmitting unit on the moveable detector device transmits its high frequency acoustic emission. Depending where the moveable detector unit is at any particular time, the emission may be received at different receiving stations, or at several receiving stations at once. Emissions received at any one station are used to calculate the distance of the moveable detector unit from that station.

From time to time the clocks in the transmitting and receiving stations are synchronized, so that compensation can be made for any error in their readings. Conveniently, this is done by determining the difference in readings of the clocks at the same absolute time, so that the difference (the error) between their readings is known. This can be done, for example, by comparing each clock with a GPS time signal (which is taken for this purpose as the absolute “correct” time), and noting the difference between the GPS time reading and he reading of the clock. This can be done either before or after the moveable sensor unit travels down the pipe and emits the acoustic emissions which are received at the receiving units. If high precision commercially available clocks are used, there will be little drift, and the synchronization need not be done each time the moveable sensor unit is caused to travel down the pipe. A person skilled in the art will know how often to synchronize, having regard to the precision of the clocks being used and the accuracy required.

In operation according to the invention, a high frequency acoustic emission is created at the transmitting station at a precisely known time. The acoustic emission is received at the receiving station and the time of receipt is noted. From these observations, the length of time taken for the acoustic emission to pass through the liquid in the pipeline from the transmitting station to the receiving station is determined. If the speed of sound of the frequency used in the type of liquid within the pipeline is not already known, this is determined. Then the distance between the two stations at the time of the emission is determined by multiplying the length of time taken for the acoustic emission to pass through the liquid in the pipeline by the speed of sound of the frequency used in the type of liquid within the pipeline.

The means for emitting the acoustic emission at a precisely known time is preferably a timer which causes emissions at precisely-timed intervals. If the timer is present, it is not absolutely necessary to have an associated recording device, provided that the clock reading is known for any one emission, as the clock readings for other emissions can be derived from this. However, it is preferred to have a recording device which shows the time of each emission as recorded by the associated clock.

Alternately, if the transmitting station is on the detector unit, means for emitting the acoustic emission can be an alarm which causes an emission when a sensor on the detector unit senses a reading beyond a pre-set limit or other predetermined alarm condition, together with a recording device which records the precise time at which the acoustic emission is emitted, as recorded by the associated clock.

As stated above, the invention makes use of a high frequency acoustic emission. The useable frequencies are dependent on the nature of the fluid in the pipeline and the diameter of the pipeline. Generally, low frequencies (below about 500 Hz.) transmit for fairly long distances along the pipeline, but they are not used in this invention because they transmit both through the liquid and the walls of the pipeline, so the signal received at the receiving station is a combination of the emission travelling through the liquid and the walls.

Above about 500 Hz, within a range of frequencies which varies with the type of fluid within the pipeline, the emissions are absorbed or damped by the fluid within the pipeline. This damping or absorption decreases as the frequency increases, and varies with the type of fluid. For most liquids, the damping is significant at frequencies in the range of about 500-18000 Hz., so these frequencies should be avoided. For gases, damping depends on the pressure of the gas as well as its composition, but generally frequencies below 18000 Hz may encounter damping, especially when the gas is pressurized. Frequencies above those at which the damping or absorption is significant for the particular fluid are useable.

To avoid any likely damping or absorption, it is preferred to use a frequency above 20 KHz, preferably in the range 20-100 KHz. and more preferably in the range 30-80 KHz. Generally, frequencies in the range 40 KHz.-80 KHz are particularly preferred in pipelines which contain water, and frequencies in the range 30 KHz.-80 KHz. are particularly preferred in pipelines which contain oil. Frequencies above 100 KHz, up to for example 200 KHz, can also be used, but are generally not preferred, because the high sampling rate required to receive these frequencies usually requires more complicated equipment than that needed for lower frequencies.

Depending on the size and construction of the transmission station, when the detector unit carries the transmission station, some frequencies within these ranges may resonate in the detector unit. It is preferred to use a resonant frequency when possible when the detector unit has the transmission station, as it is easier to create a high amplitude sound at a resonant frequency than at other nearby frequencies.

Suitably, the acoustic emission should have a duration of at least 1 ms. However, to distinguish it from possible evanescent high frequency noises within the pipeline, a longer emission, of 20 ms. to 200 ms, is preferred. Longer emissions can also be used if desired.

The emissions are spaced from each other by a time much longer than the duration of the emission, so that successive emissions do not overlap or interfere with one another at the receiving station. However, they are frequent enough so that, at the speed that the moving object is travelling, they serve to locate the object to the desired degree of accuracy. For objects travelling by entrainment in the flow of fluid in the pipeline, at typical pipeline flow rates, sufficient accuracy of location is obtained for most purposes if the emissions are repeated every 1 second to 15 seconds.

Although it is suitable in most situations to use an emission at one particular frequency, it is also possible to send a predetermined set of tones comprising several frequencies in a predetermined order. Thus, for example, a set of tones could be a sequence of four emissions of 6 ms. each in length at 42 KHz, 40.5 KHz., 39.0 KHz and 38 KHz. A set of tones like this can be used where transient high frequency noises in the pipeline from other sources are expected. The receiving station can be designed to recognize only signals having these frequencies in this order. Over distances of several kilometres, there may be some overlapping of the signals at different frequencies, caused by reflection of the signals from pipeline walls or architecture such as valves, but the sequence of signals is still recognizable.

It is surprising that high frequencies propagate for long distances through a pipeline, even though such frequencies would normally be expected to attenuate rapidly in a liquid medium. While the inventor does not wish to be bound by any theoretical explanation, it is thought that the walls of the pipeline act in a manner analogous to a waveguide to propagate high frequency acoustic emissions.

The invention is operable at all conventional pipeline pressures, from subatmospheric pressure to high pressures. The invention will also operate in gas-filled pipelines and liquid filled pipelines. In pipelines where there is liquid with gas above it (as for example in a pipeline having water with air above it), there should be a continuous path in at least one single phase (the liquid or the gas) from the transmitting station to the receiving station. A continuous path through the liquid is preferred.

In a particularly preferred embodiment, the transmitting station is aboard a detector unit and a receiving station is at the point of launch of the detector unit into the pipeline or at an inspection port along the pipeline or at the intended location of recovery of the detector unit from the pipeline. There can be several receiving stations if desired. In one method of using this apparatus, the transmitting unit transmits an acoustic emission at fixed intervals. The intervals are chosen depending on the expected speed of travel of the detector unit through the pipeline, so that an acoustic emission will occur when the detector unit is expected to have travelled approximately a desired distance. The detector unit is provided with sufficient battery capacity so that the emissions can be generated at the desired time intervals during travel along the entire length of the pipeline which the detector unit is to inspect. Also, the emissions are spaced sufficiently so that there is a sufficient interval to avoid overlap at the receiving station. For example, it is suitable in most cases to set the acoustic emissions to occur at intervals of from about ½ second to 2 minutes or even longer. Preferred intervals ranges are from 1 second to 10 seconds.

The detector unit is launched and is allowed to proceed down the pipeline to a retrieval point, with the length of pipeline to be inspected being between the launch point and the retrieval point. The detector unit is provided with conventional sensors such as for example a hydrophone, magnetometer, temperature sensor and the like for detecting anomalies. While passing through the area to be inspected, the detection unit emits the acoustic emissions at the predetermined intervals, and simultaneously the sensors aboard it collect data on the condition of the pipeline.

In a less preferred embodiment, instead of having acoustic emissions emitted at set time intervals, an emission occur whenever a sensor senses some anomaly, such as a result outside a predetermined range or when a particular condition. This ensures that a precise distance from the receiving station can be registered for an anomalous sensor reading, to permit follow-up work at the location where the anomaly was noted. For this embodiment to work properly, the precise time of sending the emission must be recorded. This can be done by recording the sensor results along with a time trace which shows the time as recorded by the clock. The precise time of sending of the emission can be determined by examining the trace to see the time at which the sensor registered the anomalous result. For convenience, the emission can also be recorded on the time trace.

At the retrieval point, the detection unit is removed from the pipeline in known fashion and the data downloaded from it. The time of sending of each emission is compared with the records of the receipt of that emission at the receiving station. The time of sending and receipt are standardized by correcting for any error between the clocks (as determined by synchronization, which is done as necessary), and the speed of transmission of sound of the emission frequency in the liquid is either known or determined empirically. From this information, the distance travelled by each emission is calculated by multiplying the time taken for that emission to travel between the transmission station and the receiving station. This provides a dataset showing the location of the detector unit when each acoustic emission was sent out (if the detector unit carries the transmitting station) or received (if the detector unit carries the receiving station). The records of observations made by the sensors aboard the moveable detector unit and the times they were made are correlated with this information This permits the location of the detector unit at the time of any anomalous sensor reading to be determined, to within the distance traveled by the detector unit in the interval between the acoustic emissions immediately before and after it. Even more precision can be obtained by interpolating data to within the interval. Of course, in the embodiment where the detector unit carries the transmitting station, even more precision is possible if the sensor is arranged to trigger an emission precisely when an anomalous sensor reading occurs.

This information can also be used to determine the velocity of the detector unit in the pipeline, by plotting the position of the detector unit at the time of successive emissions at spaced time intervals, and noting the distance travelled in the interval between emissions. This information can be used to correct distance measurements made by other conventional techniques for measurement. Also, the velocity determined for the detector unit as it approaches a receiving unit and then recedes from the receiving unit can be interpolated to find out precisely the time at which the detector unit passes the receiving unit.

If desired, emissions can be sent at predetermined time intervals and additional emissions (using a frequency or a set of tones different from the frequency or set of tones for the emissions at the set time intervals) can be sent when a sensor senses some anomalous result. This permits the tracing of the distance traveled by the detector unit and the correlation of such information with the results from sensors, while also giving additional location information when an anomalous condition is encountered.

In a less preferred embodiment, the acoustic emissions are sent at predetermined time intervals from a transmitting station at the launch point, the retrieval point, or some other point along the pipeline, for example a location between the two where there is access to the pipeline through an inspection port. The receiving station is on the detector unit. The data retrieval and processing are essentially the same. This arrangement does not permit sending an emission when an anomalous sensor reading is detected by the detector unit.

In general for liquids, sufficient accuracy for the speed of sound is obtained by using handbook values for the speed of sound of the frequency used through the type of liquid in the pipeline. However, the speed does change with temperature and pressure, so better accuracy can be obtained by doing a calibration. For gases, handbook values are less reliable, as the pressure in the pipeline fluctuates as the gas is pumped, so calibration is recommended.

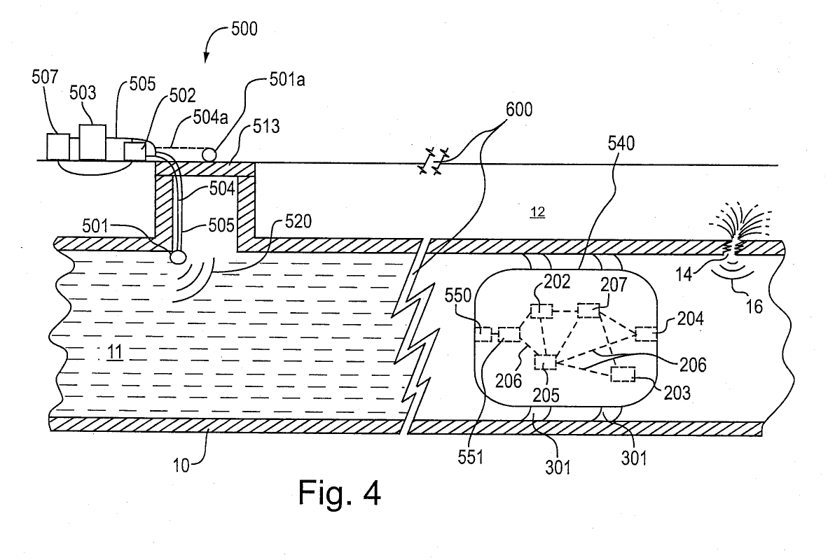

To do the calibration, the transmitting station is placed at a known location in the pipeline, such as an inspection port or a pig release station, as shown in FIG. 4 at 500. The receiving station is placed at a second location along the pipeline, such as another inspection port or a pig receiving station as shown at 400 in FIG. 4, which location is a known distance along the pipeline from the transmitting station. The detector unit is not used while doing the calibration. Preferably the two locations are less than 1 km. from one another and there are no sharp bends in the pipeline between them. A least one acoustic emission at the desired frequency is then sent from the transmitting station at a known time to the receiving station. The time at which it is received is then noted. The elapsed time for the emission to travel from the transmitting station to the receiving station is then found by subtracting the time sent from the time received, with any necessary calibration correction. As the distance travelled between the two stations is known, the speed of sound in the liquid or gas is found by dividing the distance by the elapsed time.

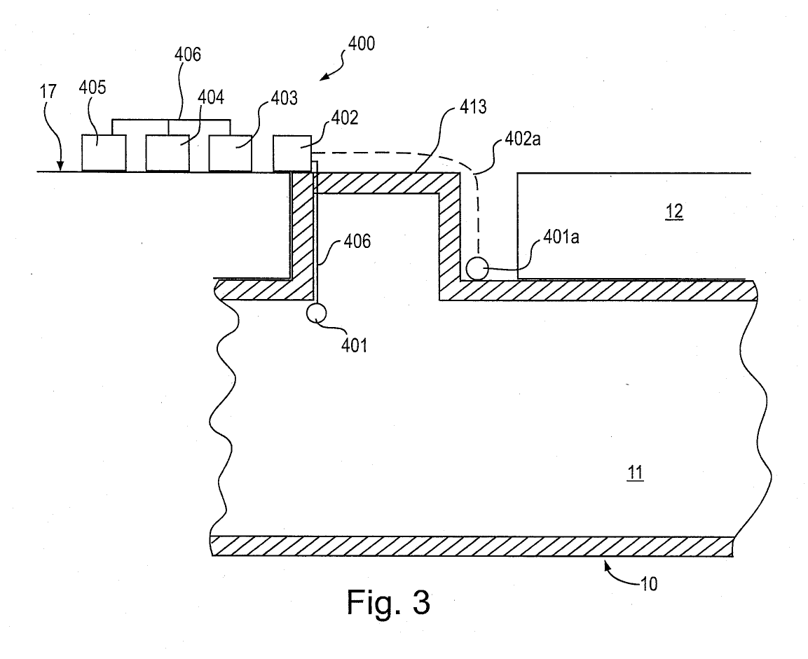

The invention can also be used to measure the length an unknown length of pipeline between two locations accessible from ground level. The pipeline, being underground, may have turns not evident from ground level, so its length may not be ascertainable from ground level. To measure its length, a transmitting station is set up as shown at 500 in FIG. 4 at one location, and a receiving unit as shown at 400 in FIG. 3 is set up at the second location. Preferably, the two locations are as close as conveniently possible, having regard to available ground locations, and the pipeline is filled with liquid which has a known speed of sound at the frequency chosen. A least one acoustic emission at the chosen frequency is then sent from the transmitting station at a known time to the receiving station. The time at which it is received is then noted. The elapsed time for the emission to travel from the transmitting station to the receiving station is then found by subtracting the time sent from the time received, with any necessary calibration correction. As the speed of sound in the liquid is known, the distance is found by is found by multiplying the speed of sound by the elapsed time.

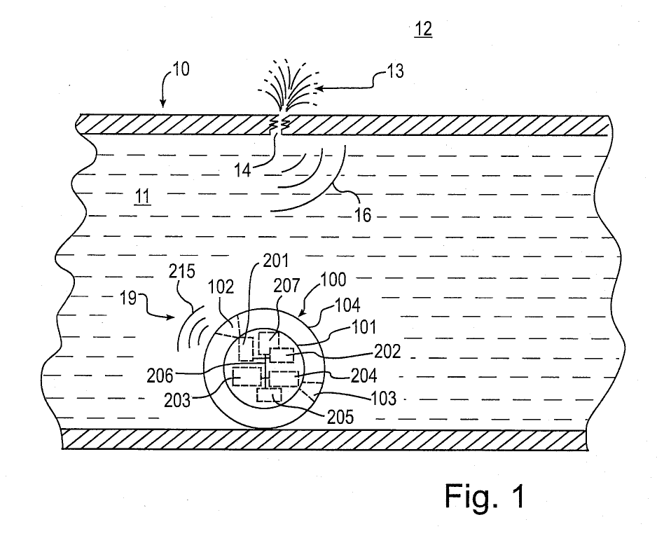

Referring to the drawings, FIG. 1 shows a pipeline 10, containing fluid 11, which can be for example, oil, water or natural gas. The pipeline is buried in the ground 12. There is a leak 14 in the pipeline, and fluid 13 is escaping from the leak into the ground as shown at 13.

The transmitting station, in this embodiment, is contained within the detector unit 100, which in this illustrative example is a ball sensor unit similar to that shown in PCT Published application WO 2006/081671 of Pure Technologies Ltd., The detector unit comprises ball-shaped sensor unit 101 within a protective outer urethane foam cover 104. Arrow 19 shows the direction of the fluid flow. As the detector unit is more dense than the fluid, it rolls along the bottom of the pipeline, pushed along by the fluid flow 19.

Within the sensor unit 101 are conventional sensors 203 and 204, for example a magnetometer 203 and a hydrophone (acoustic sensor) 204. There is a hole 103 in the protective foam cover 104 to permit the hydrophone 204 to be in direct contact with the liquid 11.

Also within the sensor unit 101 is a precise clock 202. This is connected to an acoustic emitter 201, which can emit acoustic signals at a pre-chosen frequency within the range of 20-100 KHz, The acoustic emitter can be, for example, a ¾″ diameter×0.1″ thick piezo crystal. The acoustic emitter is arranged to emit an acoustic signal at set time intervals, for example once every 3 seconds.

Alternately or in addition, acoustic emitter 201 can be a tone generator which can emit a pre-chosen sequence of acoustic signals at frequencies in the range 20-100 KHz. Preferably, there is a hole 102 in the protective foam cover 104 so that the acoustic emitter transmits directly into the fluid 11.

A memory device 205, which can be a conventional commercially-available SD memory card or flash memory, is linked by suitable circuitry 206 to record data generated by the sensors 203 and 204. Suitably, the memory device 205 also records a continuous time trace from the clock, so that the precise time of each piece of data recorded by the sensors 203 and 204 is recorded. It is also possible for the memory device to record on the same trace the time of each acoustic emission, but this is not absolutely necessary, as the acoustic emissions occur at set time intervals which are governed by the clock. In some cases (as, for example, where one sensor is a hydrophone which senses high frequencies), the data recorded by the sensor will include the periodic acoustic emissions in its recorded data.

In a preferred embodiment, the acoustic emitter 201 is a tone generator, and is linked to one or more of the sensors 203 and 204, so that the acoustic emitter will send an acoustic emission which is a specific set of tones when the sensor senses a value outside a predetermined range.

Battery 207 provides power for the elements 201-205 through circuitry 206.

In FIG. 1, the detector unit is passing adjacent the leak 13. The hydrophone 204 detects the sound of the fluid leaking from the pipeline, and the record of this sound is recorded in the memory device 205. Data showing the time of each acoustic signal is also recorded in the memory device 205.

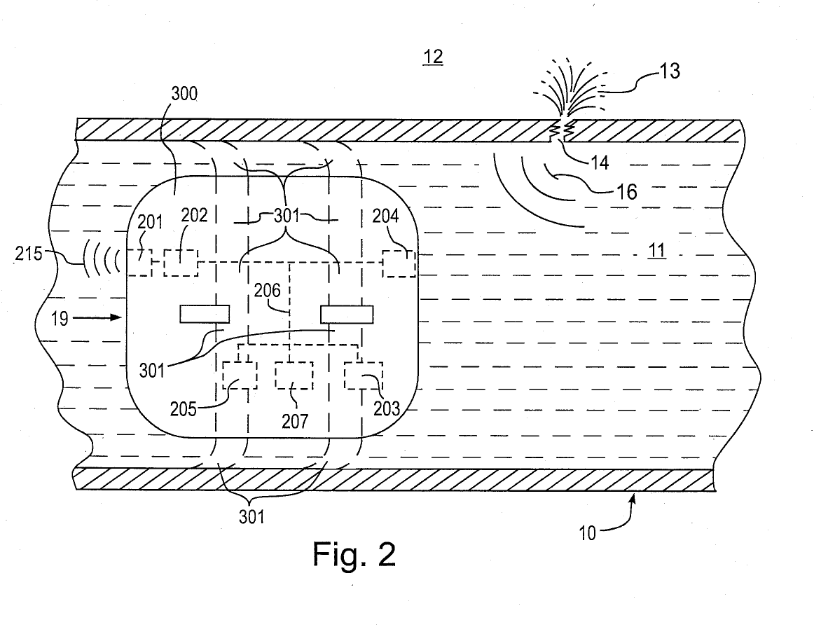

FIG. 2 shows an alternate embodiment. In FIG. 2, similar elements are labeled with the same numbers as in FIG. 1.

In FIG. 2, the detector unit is a pipeline pig 300, held in position in the pipeline 10 by sealing flaps 301 and pushed along the pipeline by the flow of the fluid in the pipeline as indicated by arrow 19. in this embodiment, the fluid 11 can be for example oil or a refined oil product, as pipelines for such products commonly use pipeline pigs for inspection, and are provided with pigging stations where pigs can be inserted into or removed from the pipeline. Within the pig are conventional sensors 203 and 204, for example a magnetometer 203 and a hydrophone (acoustic sensor) 204. Hydrophone 204 has its sensing portion on an exterior surface of the pig so that it can detect acoustic events in the surrounding fluid 11.

As in the embodiment of FIG. 1, the detector unit of FIG. 2 contains a precision clock 202 connected to an acoustic emitter 201, which can emit acoustic signals at a pre-chosen frequency within the range of 20-100 KHz, or if desired can emit a pre-chosen sequence of acoustic signals at frequencies within the range 20-100 KHz. A memory device 205, which can be a conventional flash memory or SD card, is linked by suitable circuitry 206 to record data generated by the sensors 203 and 204. The memory device 205 records also a continuous time trace from the clock, so that the precise time of each piece of data recorded by the sensors 203 and 204 is recorded. Battery 207 provides power for the elements 201-205 through circuitry 206. The acoustic emitter is arranged to emit an acoustic signal at set time intervals, for example once every 5 seconds.

The detector unit of FIG. 2 is passing adjacent the leak 13. The hydrophone 204 detects the sound of the fluid leaking from the pipeline, and the record of this sound is recorded in the memory device 205. Data showing the time of each acoustic signal is also recorded in the memory device 205.

FIG. 3 shows a receiving station 400. Again the same numbers are used to identify the same things. Typically, the receiving station is at the access port where the detector unit has been inserted into the pipeline, or at the access port where it will be removed, or at an inspection port intermediate between the two. It is preferred to have several intermediate receiving stations along the length of pipeline being examined, for example at inspection ports, if possible at intervals of every kilometre or so. In FIG. 3, the receiving station is located at inspection port 413, intermediate between the access port for insertion and the access port for removal. The precise geographical location of access port 13 is known, either by locating it from pipeline drawings and maps or by locating it by a GPS reading.

At inspection port 413, an acoustic receiver 401 which is capable of receiving the frequencies generated by the acoustic emitter 201 of FIG. 1 or FIG. 2 is located in contact with the fluid 11 or else in contact with a portion of the pipe wall or other appurtenance through which sound at the frequency of operation can pass without significant attenuation. In FIG. 3, an alternate position of acoustic receiver 401, on the outside of the pipe, is shown at 401a, with circuitry 402a (shown as a dashed line) connecting it to the other components. While better reception of sound is obtained if the receiver 401 is in contact with the liquid 11, it is often more convenient for servicing to place the receiver in contact with the pipe as at 401a or an attached appurtenance such as the inspection port, and this generally provides adequate sound pickup. Of course, if an acoustic receiver is positioned in contact with the fluid, as shown at 401, no receiver is needed in the alternate position at 401a and circuitry 402a is not needed.

Connected to the receiver 401 is an amplifier 402, memory device 403 and a precise clock 404. Power for the clock, memory device and receiver is supplied by a power source, here shown as a battery 405, and all are connected by circuitry 406. For ease of access, the clock, memory device and battery are located at or above ground level 17. Clock 404 has been synchronized with clock 202 before the detector unit is released into the pipeline, so that the error between them when measuring the same time is known.

In operation, the acoustic emitter 201 of either the ball sensor unit of FIG. 1 or the pipeline pig of FIG. 2 emits signals at predetermined intervals at a predetermined frequency. If desired, instead of a signal at a predetermined frequency, acoustic emitter 201 can emit groups of signals at predetermined frequencies in a predetermined order at such predetermined intervals. Events sensed by sensors 203 and 204, along with a continuous recording of the time displayed by clock 202, are recorded in memory device 205. It is not necessary to record the times of the acoustic emissions in the memory device (although this can be done of desired), because the emissions occur at predetermined intervals, and the time of the first emission are known because the acoustic emitter 201 is enabled at the known time when the detector unit is released into the pipeline. Additionally, if the hydrophone 204 picks up the frequency at which the signals are emitted, its recording will provide a record of such signals.

The fluid 13 leaving the pipeline leak 14 emits noise as the fluid leaves the pipeline. This noise, indicated as wavefronts 16, is picked up by the hydrophone 204 and is recorded in the memory device 205 along with the other events sensed by sensor 204.

Optionally, the memory device can have associated software which recognizes that an anomalous piece of data has been recorded and causes the acoustic emitter 201 to send out a sequence of tones immediately. This sequence is different from any tone or frequency sent out at the predetermined interval, and is to provide information which will give an exact location at which the anomalous data has been acquired. Normally, however, it is not found necessary to do this, as sufficiently precise location can be obtained by interpolating the anomalous data between the signals sent out at the predetermined intervals.

The acoustic emissions 215 pass through the fluid in the pipeline, and are received by acoustic receiver 401 or 401a (FIG. 3). In a preferred embodiment, the acoustic receiver has associated software which compares the known time of sending of each acoustic emission (which is known because the clocks of the receiving station and the transmission station are synchronized) with the arrival time of that emission and multiplies the difference by the speed of sound of that frequency to provide in real time a position of the detector unit in the pipeline. This is of particular utility when the receiving station is at the location where the detector unit is to be retrieved from the pipeline, as it permits an operator at that location to view the real-time position of the detector unit and to make preparations for its retrieval.

If this preferred embodiment is used, the real-time position of the detector unit is recorded directly. Otherwise, the precise time of receipt of each emission as shown by clock 404 is recorded in memory device 403.

After the desired inspection has been made, the contents of memory devices 403 and 205 are examined. Where anomalous readings, or readings which indicate a condition of interest, have been made by the sensors, the time that these are recorded in the memory device as having been observed are noted. The acoustic emissions issued at periodic intervals which are nearest to the time of the observation (and any special acoustic emission, if made, when the anomalous result was observed) are then compared with the record of the receipt of those emissions at the receiving station. The time lag between the sending and the receipt of each emission, multiplied by the speed of sound of that frequency in the liquid which is in the pipeline, gives a very precise measurement of the distance between the detector unit and the receiving station at the time the emission was sent. This locates precisely the location of the detector unit, and hence the sensor, when the anomalous signals were sensed by the sensor, so that further testing or pipeline repair can be carried out. The accuracy of the location of course decreases with the distance of the detector unit from the receiving unit where the results are received. Therefore, it is preferred to have receiving stations spaced along the pipeline, and to examine the relevant emissions as received by at least two receiving stations.

The error between the clocks on the receiving stations and the transmitting station is preferably determined at the beginning or end (or both) of a passage of a detector unit though the pipeline by comparison with a common standard such as a GPS time signal. If a detector unit is sent though a pipeline for an inspection taking several hours, there may be some drift, depending on the accuracy of the clocks used. Generally, the clocks which are commercially available are accurate to within about 1 millisecond per hour. More accurate clocks can be obtained commercially but are more expensive. A drift of several milliseconds an hour can be tolerated without unduly affecting the accuracy of the results, because every time that the detector unit passes a known location, such as a beacon or a receiving station, a correction factor for drift can be applied.

FIG. 4 shows an alternate embodiment in which the transmitting station is located at an access port, and the receiving station is located on a detector unit. The same numbers are used as in previous figures to indicate the same things as in those previous figures. The figure is not to scale and jagged lines 600 indicate that there is a length of pipeline of several hundred metres in length that has been omitted between the parts shown on the two sides of the jagged line.

FIG. 4 shows a transmitting station 500 located at an access port 513. The transmitting station has a precise clock 502. This is connected by circuitry 504 to an acoustic emitter 501, which can emit acoustic signals at a pre-chosen frequency within the range of 20-100 KHz, The acoustic emitter can be, for example, a ¾″ diameter×0.1″ thick piezo crystal. The acoustic emitter is arranged to emit an acoustic signal at set time intervals, for example once every 3 seconds. Preferably, there is a memory device 507 which records the acoustic signals and the time of emission of each such signal.

Alternately or in addition, acoustic emitter 501 can be a tone generator which can emit a pre-chosen sequence of acoustic signals at frequencies in the range 20-100 KHz.

The acoustic emitter is shown as being in contact with fluid 11. However, if desired, the acoustic emitter can be placed in alternative position 501a in acoustic contact with the pipeline (here shown as on the cover of access port 513) and be connected to the clock 502 by circuitry 504a.

Power source 503 powers the clock and acoustic emitter through power circuitry 505.

In this embodiment the receiving station is mounted on a detector unit, here illustrated as a pig 540 similar to pig 300 shown in FIG. 2. As in FIG. 2, the detector unit 540 contains a precision clock 202 and sensors 203 and 204. As discussed previously, sensor 204 is a hydrophone. A memory device 205, which can be a conventional flash memory or SD card, is linked by suitable circuitry 206 to record data generated by the sensors 203 and 204. The memory device 205 records also a continuous time trace from the clock, so that the precise time of each piece of data recorded by the sensors 203 and 204 is recorded. Battery 207 provides power for these elements through circuitry 206.

Unlike the pig in FIG. 2, however, pig 540 has no acoustic emitter. Instead, there is an acoustic receiver 550 which is capable of receiving the emissions generated by acoustic emitter 501 of transmitting station 500. If necessary, the sound received is amplified by an amplifier 551, and is recorded along with the traces from clock 202 and sensors 203 and 204 in memory device 205. If hydrophone 204 is designed so that it can pick up the frequency or frequencies emitted by acoustic emitter 501, then receiver 550 and amplifier 551 can be omitted, and the hydrophone can function as both acoustic sensor for leaks and the like and as the receiving station for the invention.

In operation, the acoustic emitter 501 or 501a emits signals at a predetermined interval from one another at a predetermined frequency. If desired, instead of a signal at a predetermined frequency, acoustic emitter 501 or 501a can emit groups of signals at predetermined frequencies in a predetermined order at such predetermined interval.

At the pig, receiver 550 (or hydrophone 204, if it can pick up the appropriate frequency) receives emissions sent out by acoustic emitter 501 or 501a. The emissions (which are amplified if necessary by amplifier 551), events sensed by sensor 203 and hydrophone 204, along with a continuous recording of the time displayed by clock 202, are all recorded in memory device 205.

The fluid 13 leaving the pipeline leak 14 emits noise as the fluid leaves the pipeline. This noise, indicated as wavefronts 16, is picked up by the hydrophone 204 and is recorded in the memory device 205 along with the other events sensed by sensor 204.

After the desired inspection has been made, the contents of memory device 205 and memory device 507 are examined, and the clock traces are adjusted to compensate for error between the clock readings, if any. Where the sensors show anomalous readings, or readings which indicate a condition of interest, the time that these are recorded in the memory device 205 as having been observed are noted. The acoustic emissions received nearest to the time of the observation are then compared with the record of when those emissions were sent from the transmitting station. The matching of emissions sent and emissions received by counting the number of emissions sent by the transmitting station and the number of emissions received by the receiving station since the pig's travel through the pipeline began. The time lag between the sending and the receipt of each emission, multiplied by the speed of sound of that frequency in the liquid which is in the pipeline, gives the measurement of the distance between the detector unit and the receiving station at the time the emission was sent. This locates precisely the location of the detector unit, and hence the sensor, when the anomalous signals were sensed by the sensor, so that further testing or pipeline repair can be carried out.

### EXAMPLES

### Example 1

### Water Pipeline

In a 36 inch diameter pipeline, filled with potable water at a pressure of approximately 200 psi, emissions from a transmitting station on a detector unit were transmitted through the water in the pipeline and successfully received at a receiving station at a pipeline inspection port 800 m. away. The detector unit was a ball-type sensor unit of the type shown in PCT Published application WO 2006/081671, rolling along the bottom of the pipeline. The emissions were 25 ms. in length at a frequency of 40000 Hz.

### Example 2

### Oil Pipeline

In a 10 inch diameter pipeline, filled with crude oil at a pressure of approximately 200 psi, emissions from a transmitting station from a transmitting station on a detector unit were transmitted through the oil in the pipeline and were successfully received at a receiving station at a pig launching station 200 m. away. The detector unit was a ball-type sensor unit of the type shown in PCT Published application WO 2006/081671, rolling along the bottom of the pipeline. The emissions were 25 ms. in length at a frequency of 30000 Hz.

### Example 3

### Natural Gas Pipeline

In a 200 mm. diameter natural gas pipeline, with gas at pressure varying between about 103 kPa and 270 kPa, emissions from a transmitting station on a detector unit were transmitted through the gas in the pipeline and were successfully received at a receiving station at an inspection port 50 m. away. The detector unit was a ball-type sensor unit of the type shown in PCT Published application WO 2006/081671, rolling along the bottom of the pipeline. The emissions were 25 ms. in length at a frequency of 65000 Hz.

It is understood that the invention has been described with respect to specific embodiments, and that other embodiments will be evident to one skilled in the art. The full scope of the invention is therefore not to be limited by the particular embodiments, but the appended claims are to be construed to give the invention the full protection to which it is entitled.

1. Apparatus for locating an object in a pipeline, comprising:
a transmitting station having means for transmitting in the pipeline acoustic emissions having a frequency in the range from 20 KHz to 200 KHz,
a receiving station having a receiver capable of receiving the acoustic emissions transmitted by the transmitting station,
one of said receiving station and said transmitting station being located at a known position on the pipeline and the other of said receiving station and said transmitting station being located on said object; and
clock means to determine the time taken for said acoustic emissions to travel between the transmitting station and the receiving station.

2. (canceled)

3. (canceled)

4. (canceled)

5. (canceled)

6. (canceled)

7. (canceled)

8. Apparatus as claimed in claim 1, in which the object is a detector unit moveable within the pipeline and equipped with at least one sensor to detect at least one anomalous condition within the pipeline.

9. (canceled)

10. (canceled)

11. Apparatus as claimed in claim 1 in which;
said transmitting station is located on such object and said clock means comprises first clock means associated with said transmitting station for transmitting said acoustic emissions at known times or at predetermined intervals; and
said receiving station is located on the pipeline at a known location and has an acoustic receiver capable of receiving the acoustic emissions transmitted by the transmitting station, and said clock means additionally comprises second clock means associated with the receiving station to determine the times said acoustic emissions are received by said receiving station.

12. Apparatus as claimed in claim 11, including recording means associated with the transmitting station to record acoustic emissions sent by the transmitting station.

13. Apparatus as claimed in claim 11, including recording means associated with the receiving station to record acoustic emissions received by the receiving station.

14. Apparatus as claimed in claim 11, in which the error if any between the reading of the first clock means and the reading of the second clock means is known.

15. Apparatus as claimed in claim 11, in which the object is a detector unit equipped with at least one sensor to detect at least one anomalous condition within the pipeline.

16. (canceled)

17. Apparatus as claimed in claim 1, in which the means for transmitting acoustic emissions transmits emissions having a frequency in the range from 20 KHz to 100 KHz.

18. Apparatus as claimed in claim 1, in which the means for transmitting acoustic emissions transmits emissions having a frequency in the range from 30 KHz to 80 KHz.

19. Apparatus as claimed in claim 1, in which the means for transmitting acoustic emissions transmits emissions having a duration in the range of from 1 millisecond to 200 milliseconds.

20. Apparatus as claimed in claim 1, in which the means for transmitting acoustic emissions transmits emissions having a duration in the range from 20 milliseconds to 200 milliseconds.

21. Apparatus as claimed in claim 1, in which each said acoustic emission is a predetermined series of tones of different frequencies.

22. Apparatus as claimed in claim 1 in which the acoustic emissions are spaced from one another by a period of from 1 second to 15 seconds.

23. Apparatus as claimed in claim 15, in which the sensor is equipped so that the detection of an anomalous condition by the sensor causes the transmitting station to transmit an acoustic emission.

24. A method for determining the position of an object in a pipeline which contains fluid, comprising;
transmitting in the pipeline acoustic emissions having a frequency in the range from 20 KHz to 200 KHz from the object within the pipeline,
receiving the acoustic emissions at a known position on or in the pipeline,
determining the time taken for said acoustic emissions to travel between the object and the known position, and
determining the speed of sound in the fluid in the pipeline.

25. A method for determining the position of an object in a pipeline which contains fluid, comprising;
transmitting in the pipeline acoustic emissions having a frequency in the range from 20 KHz to 200 KHz from a known position on or in the pipeline,
receiving the acoustic emissions at the object,
determining the time taken for said acoustic emissions to travel between the known position and the object, and
determining the speed of sound in the fluid in the pipeline.

26. (canceled)

27. A method as claimed in claim 24 in which the acoustic emissions have a frequency in the range from 30 KHz to 80 KHz.

28. A method as claimed in claim 24, in which the acoustic emissions have a duration in the range of from 1 millisecond to 200 milliseconds.

29. (canceled)

30. (canceled)

31. (cancelled)

32 A method as claimed in claim 25 in which the acoustic emissions have a frequency in the range from 30 KHz to 80 KHz.

33. A method as claimed in claim 25, in which the acoustic emissions have a duration in the range of from 1 millisecond to 200 milliseconds.
